(19) United States
(12) Patent Application Publication
(10) Pub. No.: US 2011/0189568 A1
(43) Pub. Date: Aug. 4, 2011

(54) FUEL CELL SYSTEM

(75) Inventors: Takeshi MINAMIURA, Kobe-shi (JP); Takashi Yasuo, Kobe-shi (JP)

(73) Assignee: SANYO ELECTRIC CO., LTD.

(21) Appl. No.: 13/016,515

(22) Filed: Jan. 28, 2011

(30) Foreign Application Priority Data
Jan. 29, 2010 (JP) 2010-019230
Nov. 30, 2010 (JP) 2010-267394

(51) Int. Cl. H01M 8/04; H01M 8/24

(52) U.S. Cl. 429/428

(57) ABSTRACT

A fuel cell system has two fuel cell modules each arranged in a plane. In the fuel cell modules each including a plurality of membrane electrode assemblies arranged in a plane, hydrogen stored in a fuel cartridge is fed to anodes of the fuel cell modules. A control unit performs control of connecting the two fuel cell modules alternately to an external load, when the external load connected to a fuel cell system is within a prescribed threshold value and at least one of the temperature of one of the fuel cell modules and the temperature of the other of the fuel cell modules is at or below a prescribed threshold temperature.

This application is based upon and claims the benefit of priority from the prior Japanese Patent Applications No. 2010-019230, filed on Jan. 29, 2010, and Japanese Patent Application No. 2010-267394, filed on Nov. 30, 2010, the entire contents of which are incorporated herein by reference.

### BACKGROUND OF THE INVENTION

1. Field of the Invention

The present invention relates to a fuel cell system. More particularly, the invention relates to a planar fuel cell system.

2. Description of the Related Art

A fuel cell is a device that generates electricity from hydrogen and oxygen so as to obtain highly efficient power generation. A principal feature of the fuel cell is its capacity for direct power generation which does not undergo a stage of thermal energy or kinetic energy as in the conventional power generation. This presents such advantages as high power generation efficiency despite the small scale setup, reduced emission of nitrogen compounds and the like, and environmental friendliness on account of minimal noise or vibration. In this manner, the fuel cells are capable of efficiently utilizing chemical energy in its fuel and, as such, environmentally friendly. Fuel cells are therefore expected as an energy supply system for the twenty-first century and have gained attention as a promising power generation system that can be used in a variety of applications including space applications, automobiles, mobile devices, and large and small scale power generation. Serious technical efforts are being made to develop practical fuel cells.

In particular, polymer electrolyte fuel cells feature lower operating temperature and higher output density than the other types of fuel cells. In recent years, therefore, the polymer electrolyte fuel cells have been emerging as a promising power source for mobile devices such as cell phones, notebook-size personal computers, PDAs, MP3 players, digital cameras, electronic dictionaries or electronic books. Well known as the polymer electrolyte fuel cells for mobile devices are planar fuel cells, which have a plurality of single cells arranged in a plane. As a fuel to be used for this type of fuel cells, hydrogen stored in a hydrogen storage alloy or a hydrogen cylinder, as well as methanol, is a subject of continuing investigations.

As the heat balance within the fuel cell varies due to a change in the ambient environment and variations in a load power, the temperature of the fuel cell changes. It is speculated that when the load power is high, the temperature of the fuel cell rises and the performance thereof deteriorates due to a drying electrolyte member. Particularly in the planar fuel cells where cells are arranged in the same plane, surfaces which are open to the atmosphere are large and therefore the electrolyte member is more likely to be dry. Known in the art is a structure where a porous material (spaces through which air/moisture flows) that covers an air electrode (cathode) side of the fuel cell is used to prevent the electrolyte membrane from being dried out. However, since the opening ratio of the porous material is designed for the purpose of preventing the dry-out, the heat generation is not in the sufficient level due to the balancing relation between the generated water and the heat when the load power is low. Thus, there is a problem of flooding to be addressed where the generated water is likely to condensate.

Where the performance varies among a plurality of fuel cell modules, the temperature of a fuel cell is high in a fuel cell module of the highest performance, and the temperature thereof is low in a fuel cell module of the lowest performance when the plurality of fuel cells are connected in parallel. Thus, the temperature difference in a fuel cell during power generation (especially at the maximum output) becomes large. As a result, the fuel cell having a high temperature suffers dry-out problem. Also, there are cases where a cooling system capable of performing cooling control individually is required to address the dry-out problem.

### SUMMARY OF THE INVENTION

The present invention has been made in view of the foregoing problems, and a purpose thereof is to provide a fuel cell system capable of stably carrying out power generation operation in the event that the load power varies.

One embodiment of the present invention relates to a fuel cell system. The fuel cell system comprises: fuel cell modules of n units electrically connected in parallel with an external load, n being an integer greater than or equal to 2; a connection switching means capable of switching a connection between each of the fuel cell modules and the external load; and a control unit configured to perform a switching operation of switching the fuel cell modules, connected to the external load, by using the connection switching means, in such manner that the number of fuel cell modules simultaneously connected to the external load is m (m=1, 2, 3, . . . , n−1) according to the external load, when the temperature of at least one of the fuel cell modules is less than or equal to a predetermined temperature. Here, the load means the sum of an external load (application) and a secondary cell load (a secondary cell built within the fuel cell system).

By employing this embodiment, the number of fuel cell modules connected to the load power is changed according to the load power, and the fuel cell module(s) connected to the load is (are) changed according to the load power. Thus, the value of current flowing to each of the fuel cell modules can be made approximately equal. As a result, the temperature of the fuel cell modules remains within a fixed range and therefore the dry-out and the condensation of generated water are suppressed. Furthermore, the power generation operation of the fuel cell system can be stabilized.

In the above-described fuel cell system, the fuel cell modules of n units may be arranged in a plane. Also, the fuel cell modules of n units may be disposed in parallel in such a manner that main surfaces of the adjacent fuel cell module face each other.

In the above-described fuel cell system, the control unit may switch a combination of the fuel cell modules connected to the external load, at every fixed times. Also, when the temperature of each of the fuel cell modules of n units becomes higher than a predetermined temperature, the control unit may connect the fuel cell modules of n units to the external load. Also, when the control unit performs the switching operation, the control unit may connect the fuel cell modules to be connected to the external load, to the external load; after a predetermined length of time has elapsed, the control unit may cut off a fuel cell module to be cut off from the external load, from the external load. Also, when the external load becomes m/n or below based on a maximum load, the control unit performs the switching operation of sequentially switching the fuel cell modules connected to the external load by using said connection switching means in such a manner that the number of fuel cell modules simultaneously connected to the external load is m.

Also, when, in any of the above-described fuel system, the temperature of any particular fuel cell module is higher than an average value of the all fuel cell modules of n units by at least a predetermined value, the control unit may restrict the current of the any particular fuel module according to the temperature of the any particular fuel cell module. Also, when, in any of the above-described fuel system, the difference between a maximum temperature and a minimum temperature in temperatures of the all fuel cell modules of n units is higher than a predetermined value, the control unit may restrict the current of a single fuel cell module or a plurality of fuel cell modules in descending order in temperature among the all fuel cell modules of n units.

Also, when, in any of the above-described fuel system with all of the fuel cell modules being connected to the external load, which is low, and therefore the flooding being under way, the output voltage value of at least one of the fuel cell modules falls below a predetermined voltage value relative to a predetermined current value or when a variation of the output voltage of at least one of the fuel cell modules is higher than or equal to a predetermined range of variation, the control unit may perform a switching operation of switching the fuel cell modules, simultaneously connected to the external load, according to the load power. Thus, the load of the fuel cell modules in operation approaches the rating and the flooding and the like problems are resolved, and thereby the power generation status of these fuel cell modules is improved and the outputs thereof are stabilized. At the same time, the diffusion polarization and the like are reduced, so that the fuel can be used effectively and therefore the fuel efficiency can be improved.

It is to be noted that any arbitrary combinations or rearrangement, as appropriate, of the aforementioned constituting elements and so forth are all effective as and encompassed by the embodiments of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is an exploded perspective view showing a rough structure of a fuel cell system according to an embodiment of the present invention;

FIG. 2 is a feature sectional view taken along line A-A of FIG. 1;

FIG. 3 is a block diagram showing a fuel supply passage in a fuel cell system in an embodiment;

FIG. 4 is a circuit diagram showing a circuit configuration of a fuel cell system according to an embodiment;

FIG. 5 is a first flowchart showing an operation of a fuel cell system according to an embodiment;

FIG. 6 is a graph showing I-V characteristics, I-P characteristics of a fuel cell module, the dependence of temperature on the current, and the dependence of generated water on the current;

FIGS. 7A to 7D are timing charts showing a first exemplary operation of a fuel cell system;

FIG. 7A shows a change of load power over time;

FIG. 7B shows a connection status (change in on/off state) in a fuel cell module 20a;

FIG. 7C shows a connection status (change in on/off state) in a fuel cell module 20b;

FIG. 7D shows a change of power in each fuel cell module;

FIG. 8 is a graph showing a change in temperature of a fuel cell system where a conventional control method is used;

FIG. 9 is a graph showing a change in temperature of a fuel cell system where a control method for a first exemplary operation is used;

FIG. 10 is a graph showing the dependence of dry-out temperature and flooding temperature on the humidity;

FIGS. 11A to 11D are timing charts showing a second exemplary operation of a fuel cell system;

FIG. 11A shows a change of load power over time;

FIG. 11B shows a connection status (change in on/off state) in a fuel cell module 20a;

FIG. 11C shows a connection status (change in on/off state) in a fuel cell module 20b;

FIG. 11D shows a change of power in each fuel cell module;

FIG. 12 is a second flowchart showing an operation of a fuel cell system according to an embodiment;

FIGS. 13A to 13D are timing charts showing a third exemplary operation of a fuel cell system;

FIG. 13A shows a change of load power over time;

FIG. 13B shows a connection status (change in on/off state) in a fuel cell module 20a;

FIG. 13C shows a connection status (change in on/off state) in a fuel cell module 20b;

FIG. 13D shows a change of power in each fuel cell module;

FIG. 14 is a third flowchart showing an operation of a fuel cell system according to an embodiment;

FIG. 15 is an exploded perspective view showing a rough structure of a fuel cell system according to a first modification;

FIG. 16 is a conceptual diagram showing I-V characteristics and I-P characteristics of a fuel cell module at the beginning of start of power generation and also showing I-V characteristics and I-P characteristics of a fuel cell module after continuously operated under a low load, with flooding occurring, for a predetermined length of time;

FIG. 17 is an exploded perspective view showing a rough structure of a fuel cell system according to a second modification; and

FIG. 18 is a feature sectional view taken along line A-A of FIG. 17.

### DETAILED DESCRIPTION OF THE INVENTION

The invention will now be described by reference to the preferred embodiments. This does not intend to limit the scope of the present invention, but to exemplify the invention.

Hereinbelow, the embodiments will be described with reference to the accompanying drawings. Note that in all of the Figures the same reference numerals are given to the same components and the description thereof is omitted as appropriate.

### Embodiments

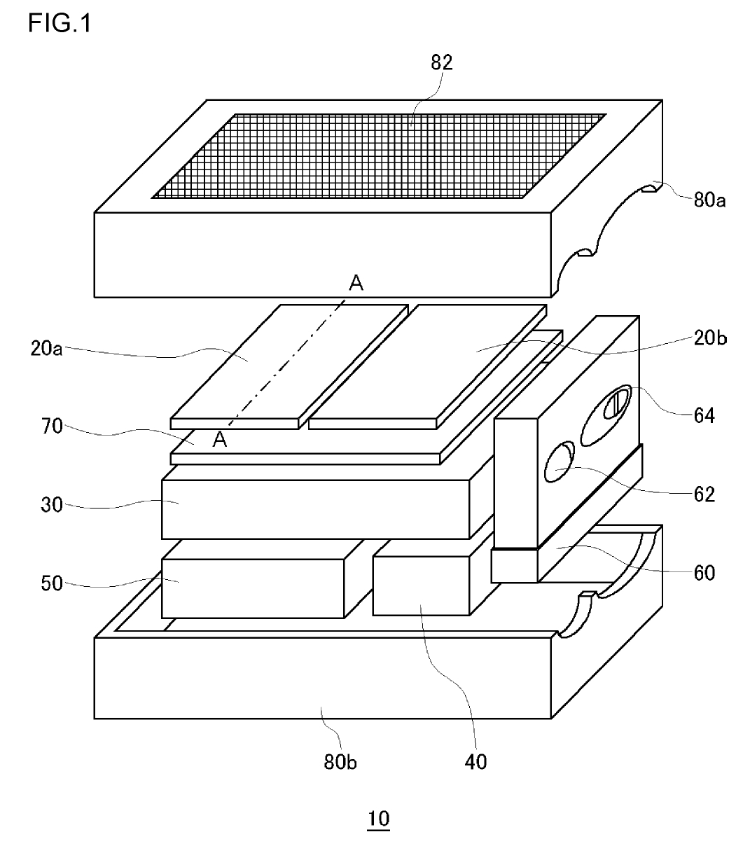

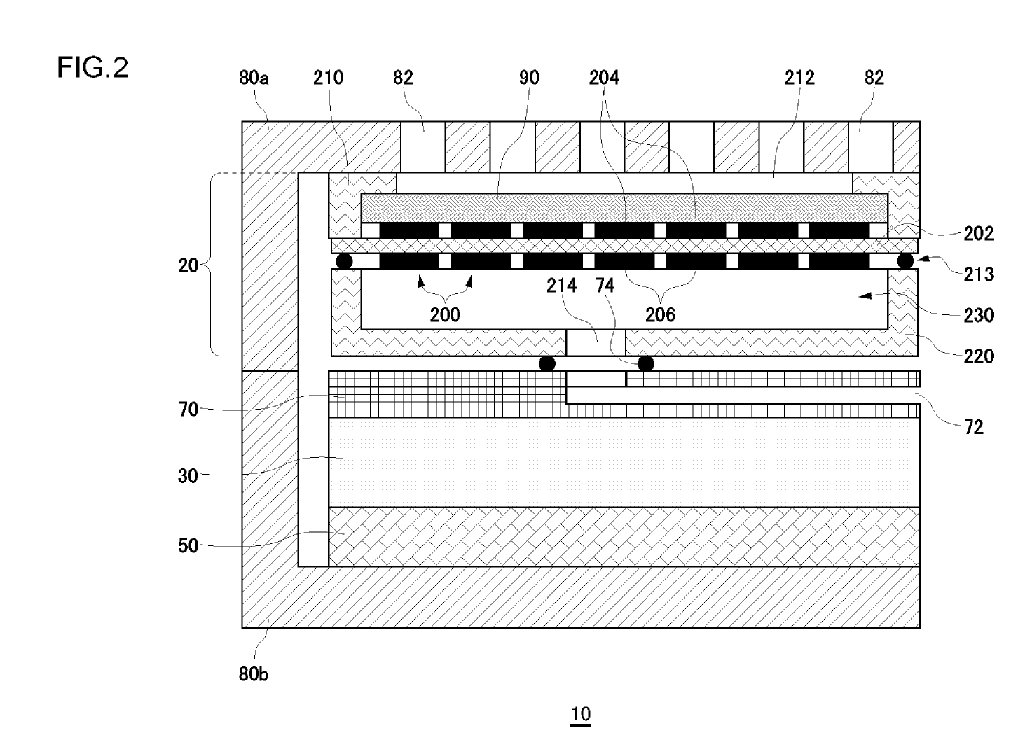

FIG. 1 is an exploded perspective view showing a rough structure of a fuel cell system according to an embodiment of the present invention. FIG. 2 is a feature sectional view illustrating schematically the fuel system according to the embodiment. A fuel cell system 10 includes a fuel cell module 20a, a fuel cell module 20b, a metal hydride cartridge 30 (hereinafter simply referred to as “fuel cartridge”) for storing hydrogen supplied to the fuel cell modules 20a and 20b, a control unit 40, a secondary cell 50, related components (a regulator 60, a fuel supply plate 70 and the like), and a top casing 80a and a bottom casing 80b that house all of the above-described components. In the following description, the fuel cell module 20a and the fuel cell module 20b are generically referred to as “fuel cell module 20” or “fuel cell modules 20” on some occasions. Note also that a “metal hydride” may also be called a hydrogen storage alloy.

As shown in FIG. 2, each fuel cell module 20 includes, as principal components, a membrane electrode assembly 200, a cathode housing 210, and an anode housing 220.

A plurality of membrane electrode assemblies 200 (single cells) include an electrolyte membrane 202, a plurality of cathode catalyst layers 204 which are disposed slightly apart from each other and which are provided on one surface of the electrolyte membrane 202, and a plurality of anode catalyst layers 206 which are disposed corresponding respectively to the plurality of cathode catalyst layers 204 and which are provided on the other surface of the electrolyte membrane 202. In the present embodiment, a plurality of cathode catalyst layers 204 are disposed in such a manner as to be slightly apart from each other on one surface of the electrolyte membrane 202, whereas a plurality of anode catalyst layers 206 are disposed counter to the respective corresponding cathode catalyst layers 204 in such a manner as to be slight apart from each other on the other surface of the electrolyte membrane 202.

The electrolyte membrane 202, which may show excellent ion conductivity in a moist or humidified condition, functions as an ion-exchange membrane for the transfer of protons between the cathode catalyst layer 204 and the anode catalyst layer 206. The electrolyte membrane 202 is formed of a solid polymer material such as a fluorine-containing polymer or a nonfluorine polymer. The material that can be used is, for instance, a sulfonic acid type perfluorocarbon polymer, a polysulfone resin, a perfluorocarbon polymer having a phosphonic acid group or a carboxylic acid group, or the like. An example of the sulfonic acid type perfluorocarbon polymer is a Nafion ionomer dispersion (made by DuPont: registered trademark) 112. Also, an example of the nonfluorine polymer is a sulfonated aromatic polyether ether ketone, polysulfone or the like. The thickness of the electrolyte membrane 30 may be about 10 to 200 μm, for instance.

The cathode catalyst layer 204 is formed on one surface of the electrolyte membrane 202. Air is supplied to the cathode catalyst layers 204 from outside through air inlets 82 provided in the top casing 80a and an opening 212 provided in the cathode housing 210. The anode catalyst layer 206 is formed on the other surface of the electrolyte membrane 202. Hydrogen released from the fuel cartridge 30 is supplied to the anode catalyst layer 206. A single cell is structured by a pair of cathode catalyst layer 204 and anode catalyst layer 206 with the electrolyte membrane 202 held between the cathode catalyst layer 204 and the anode catalyst layer 206. Each single cell generates electric power through an electrochemical reaction between the fuel (e.g. hydrogen) and oxygen in the air.

The cathode catalyst layer 204 and the anode catalyst layer 206 are each provided with ion-exchange material and catalyst particles or carbon particles as the case may be.

The ion-exchange material provided in the cathode catalyst layer 204 and the anode catalyst layer 206 may be used to promote adhesion between the catalyst particles and the electrolyte membrane 30. This ion-exchange material may also play a role of transferring protons between the catalyst particles and the electrolyte membrane 202. The ion-exchange material may be formed of a polymer material similar to that of the electrolyte membrane 202. A catalyst metal may be a single element or an alloy of two or more elements selected from among Sc, Y, Ti, Zr, V, Nb, Fe, Co, Ni, Ru, Rh, Pd, Pt, Os, Ir, lanthanide series element, and actinide series element. Furnace black, acetylene black, ketjen black, carbon nanotube or the like may be used as the carbon particle when a catalyst is to be supported. The thickness of the cathode catalyst layer 204 and the anode catalyst layer 206 may be from about 10 to 40 μm, for instance.

A porous material 90 is formed on a cathode side of the electrolyte membrane 202 in such a manner as to cover the cathode catalyst layers 204. The material used for the porous material 90 is fluororesin, for instance. The formation of the porous material 90 on the cathode catalyst layers 204 can ensure a flow of air and water vapor into the cathode catalyst layers 204 from the exterior and also suppress the occurrence of dry-out in each single cell. The allowable range of porosity ratio of the porous material 90 is designed so that the range thereof can suppress the dry-up of each single cell.

A plurality of single cells are connected in series in such a manner that a single cell of anode catalyst layer 206 in one of adjacent single cells and a single cell of cathode catalyst layer 204 on the other thereof are electrically connected to each other by the use of an electrical connecting component (not shown) such as an interconnector.

The casings of the fuel cell module 20 is formed such that edges of side walls of the cathode housing 210 and edges of side walls of the anode housing 220 face each other along an outer periphery of the electrolyte membrane 202.

The cathode housing 210 has an opening formed in its surface facing the cathode catalyst layers 204 of the fuel cell module 20. Air is supplied to the cathode catalyst layers 204 of the fuel cell 20 through the air inlets 82 provided in the top casing 80a and the opening 212 and the porous material 90 provided in the cathode housing 210. Note that a peripheral edge part of the porous material 90 is held by the cathode housing 210 located at an peripheral edge of the opening 212 and therefore the adhesion between the cathode catalyst layers and the porous material 90 improves.

A surface of the anode housing 220 facing the electrolyte membrane 202 is provided in such a manner as to be spaced apart from the anode catalyst layer 206. A fuel gas chamber 230 is formed between the anode catalyst layers 206 and the anode housing 220. The anode housing 220 has a fuel intake port 214 located on a surface facing the anode catalyst layer 206 of the fuel cell module 20. Hydrogen supplied from the fuel cartridge 30 is introduced into the fuel gas chamber 230 through the fuel intake port 214 and is used for the power generation of each signal cell. A packing 213 is provided in a prescribed manner between the edge of side wall of the anode housing 220 and the outer periphery of the electrolyte membrane 202, thereby improving the airtightness of the fuel gas chamber 230.

It is desirable that a heat insulating material is placed between adjacent fuel cell modules 20, namely at a boundary region between each fuel cell module 20. As a result, heat is less likely to escape from a fuel cell module 20 in operation to a fuel cell module 20 not in operation and therefore an advantageous effect described later can be achieved.

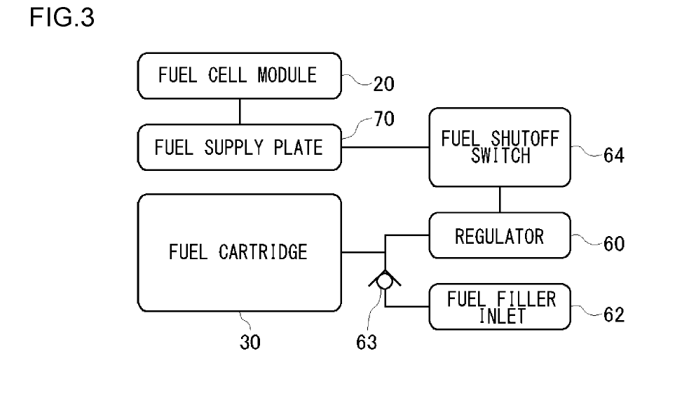

FIG. 3 is a block diagram showing a fuel supply passage in a fuel cell system in an embodiment.

With an external cylinder (not shown), for storing hydrogen to be refilled, connected to a fuel filler inlet 62, hydrogen can be supplied to the hydrogen storage alloy housed in the fuel cartridge 30. Note that a piping between the fuel filler inlet 62 and the fuel cartridge 30 is provided with a check valve 63, so that hydrogen stored in the fuel cartridge 30 is prevented from being leaked to the exterior.

Hydrogen stored in the fuel cartridge 30 is supplied to a fuel cell plate 70 via a regulator 60. The pressure of hydrogen is reduced by the regulator 60 when hydrogen is supplied to the hydrogen storage alloy from the external cylinder or when hydrogen is released from the hydrogen storage alloy. Hence, the anode of each fuel cell module 20 is protected.

A fuel conduit 72 (see FIG. 2) used to distribute hydrogen, having passed through the regulator 60, to each fuel cell module 20 is provided in the fuel supply plate 70. An outlet end of the fuel conduit 72 is provided in a position corresponding to the fuel intake port 214. Hydrogen having passed through the fuel conduit 72 passes through the fuel intake port 214 from the outlet end of the fuel conduit 72 and is then introduced into the fuel gas chamber 230 of the fuel cell module 20. Packings 74 are provided between the fuel cell module 20 and the fuel supply plate 70 in order that a space between the outlet end of the fuel conduit 72 and the fuel intake port 214 can be a sealed space.

The supply of hydrogen from the regulator 60 to the fuel supply plate 70 can be shut off by a fuel shutoff switch 64. The supply of hydrogen is shut off while the fuel cell system is not in use. This can suppress the fuel from being consumed as a result of dissipation of a small amount of hydrogen. Also, if a malfunction occurs in the fuel cell system 10 or the like situation occurs, emergency shutoff will be done by the use of the fuel shutoff switch 64, so that safety can be ensured.

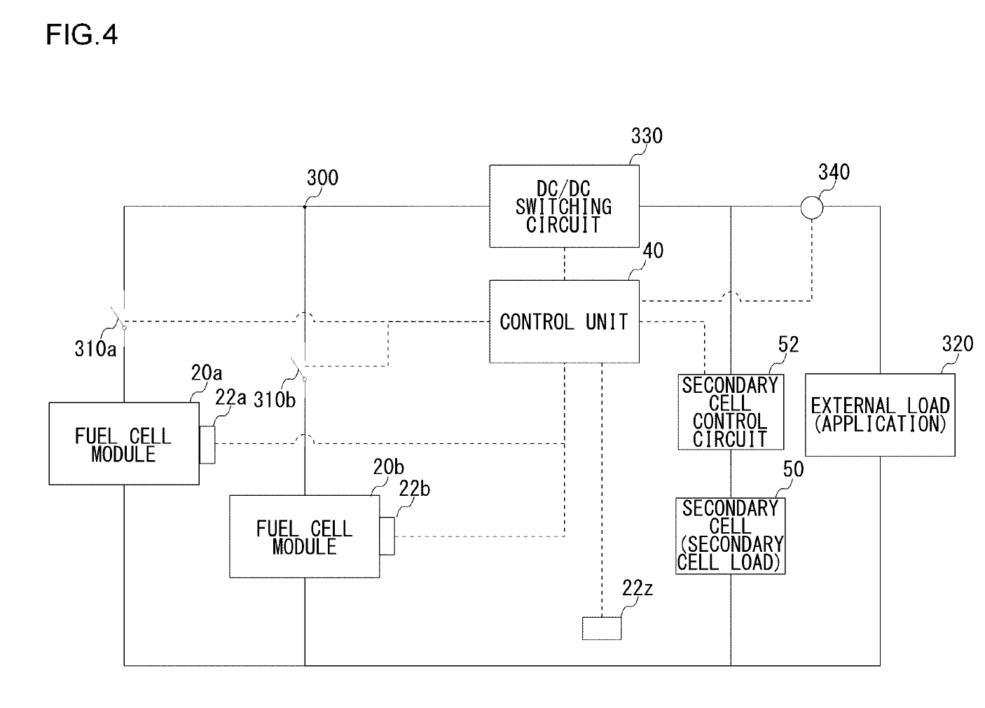

FIG. 4 is a circuit diagram showing a circuit configuration of a fuel cell system according to an embodiment. The fuel cell module 20a and the fuel cell module 20b are connected in parallel with each other, and a switch 310a is provided between a connection node 300 and the fuel cell module 20a. The on and off of the switch 310a are controlled by the control unit 40. Turning on and off the switch 310a allows the switching of states between a state where the fuel cell module 20a is connected to an external load 320 and a state where the fuel cell module 20a is cut off from the external load 320. A switch 310b is provided between the connection node 300 and a positive electrode of the fuel cell module 20b. The on and off of the switch 310b are controlled by the control unit 40. Turning on and off the switch 310b allows the switching of states between a state where the fuel cell module 20b is connected to the external load 320 and a state where the fuel cell module 20b is cut off from the external load 320. Note here that the external load 320 may be a power supply load such as a mobile device.

The temperatures of the fuel cell module 20a and the fuel cell module 20b are measured by temperature sensors 22a and 22b, respectively. The temperatures measured by the temperature sensors 22a and 22b are each sent to the control unit 40. The temperature measured by the temperature sensor 22a is a temperature near the electrolyte membrane 202 of the fuel cell module 20a or a temperature proportional to the temperature near the electrolyte membrane 202 of the fuel cell module 20a. Similarly, the temperature measured by the temperature sensor 22b is a temperature near the electrolyte membrane 202 of the fuel cell module 20b or a temperature proportional to the temperature near the electrolyte membrane 202 of the fuel cell module 20b. A temperature sensor 22z measures the temperature of ambient atmosphere.

A DC power generated by the fuel cell module 20 is converted to a predetermined voltage (e.g., 24 V) by a DC/DC converter (conversion circuit) 330, and is then supplied to the secondary cell 50 and the external load 320 connected in parallel with the fuel cell module 20. A predetermined voltage to be boosted by the DC/DC converter 330 is set by the control unit 40.

The secondary cell 50 may be a lithium-ion secondary battery, for instance. The charge or discharge of the secondary cell 50 is controlled by a secondary cell control circuit 52.

For the measurement of the load power of the external load 320, it is possible to calculate the load power thereof by measuring the current value if the output voltage of the DC/DC converter 330 is constant. The current value may be calculated, for example, by measuring a voltage across a resistor such as shunt resistor. More specifically, the current value measured by a current detector 340 provided between the connection node 300 and the DC/DC converter 330 is transmitted to the control unit 40 where the value of external load power is calculated based on the current value transmitted. If the output voltage varies, both the current value and the voltage value will be measured and these two values are operated with each other under a rule, so that the external load power can be calculated. Also, a similar current detector may also be provided in the secondary cell control circuit 52. In this case, a secondary cell load power may also be measured and the load power can be calculated by summing the external load power and the secondary cell load power.

The control unit 40 is configured as a microcomputer comprised of a CPU, a RAM, a ROM and so forth, and the control unit 40 controls the operation of the fuel cell system 10 according to programs stored in the ROM. More specifically, the control unit 40 controls the on and off of the switch 310a and 310b, based on (i) information on the temperature inputted from each fuel cell module 20 and (ii) the sum of the value of the external load calculated using the current value measured by the current detector 340 and the value of load, of the secondary cell during the charging, measured by the secondary cell control circuit 55. An on-off control of the switches 310a and 310b performed by the control unit 40 will be discussed later.

(Operation Flow of Fuel Cell System)

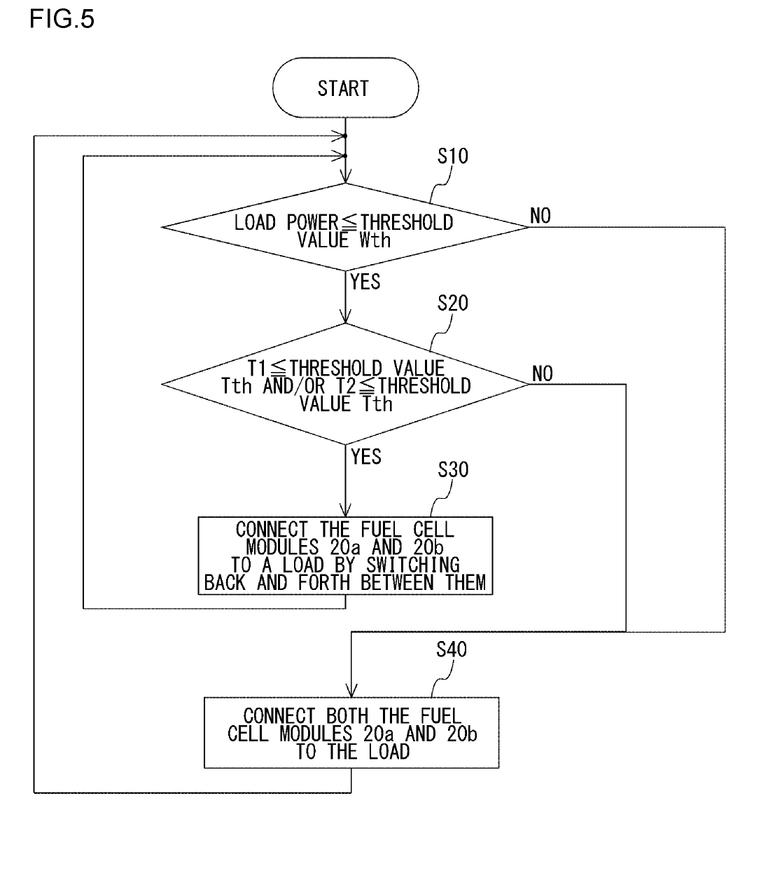

FIG. 5 is a first flowchart showing an operation of the fuel cell system 10 according to an embodiment. Determined first is whether the sum of the external load electrically connected to the fuel cell system 10 and the load of the secondary cell during charging is less than or equal to a predetermined threshold value Wth or not (S10).

Here, the threshold value Wth is ½ of the maximum load where the external load becomes maximum. If the load is less than or equal to the predetermined threshold value Wth (Yes of S10), whether a temperature T1 of the fuel cell module 20a is a predetermined threshold value Tth or below or a temperature T2 of the fuel cell module 20b is the predetermined temperature Tth or below will be determined (S20). The threshold value Tth is a temperature at which the flooding is likely to occur in each of the fuel cell modules 20, and such a threshold value Tth is, for example, about 35° C. if the temperature of ambient atmosphere is 25° C. This threshold value Tth varies according as the temperature of ambient atmosphere varies.

If the temperature of at least one of the fuel cell module 20a and the fuel cell module 20b is the predetermined threshold value Tth or below (Yes of S20), the fuel cell system 10 will be operated (hereinafter this operation will be called “switching operation”) in a manner such that the fuel cell module 20a or the fuel cell module 20b is connected to the external load by switching them alternately (S30). At the switching operation, the timing with which the fuel cell modules 20a and 20b are switched is the timing at which the time duration, which has elapsed after one of the fuel cell modules 20 is connected to the external load, has reached a predetermined length, and such timing is about 5 to 300 seconds, for instance.

If, on the other hand, the external load exceeds the predetermined threshold value Wth (No of S10) and/or if the temperature of both the fuel cell module 20a and the fuel cell module 20b exceeds the predetermined threshold value Tth (No of S20), both the fuel cell module 20a and the fuel cell module 20b are connected to the external load (S40).

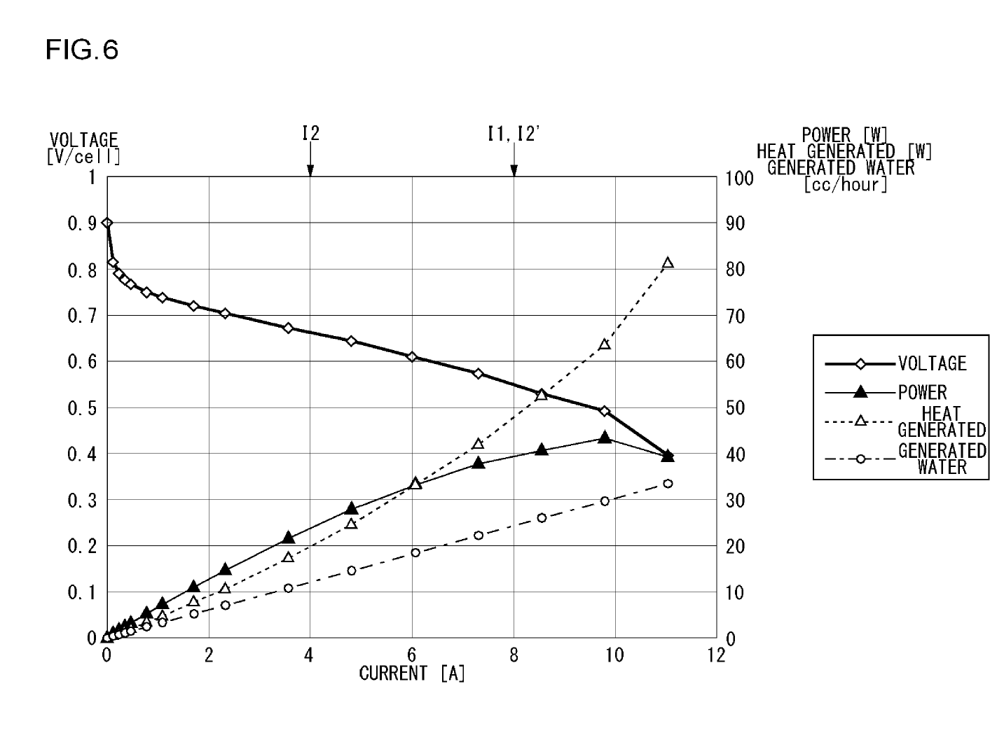

FIG. 6 is a graph showing I-V characteristics, I-P characteristics of a fuel cell module, the dependence of temperature on the current, and the dependence of generated water on the current. If all of fuel cell modules are constantly connected to the external load, the current of the fuel cell modules will vary greatly according to the external load. A current I2 of the fuel cell modules when the load is ½ of the maximum load, is ½ of a current I1 when the load is at the maximum. In this manner, as the current of the fuel cell modules varies depending on the external load, the temperature of the fuel cell modules and the amount of generated water vary greatly depending on the current. In contrast thereto, by employing the above-described switching operation, a current I2′ of each fuel cell module when the load is ½ of the maximum load can be made equal to the current I1 at the maximum load. Hence, the temperature of the fuel cell module and the amount of generated water can be maintained both at the maximum load and at a lower load.

(Description of First Exemplary Operation)

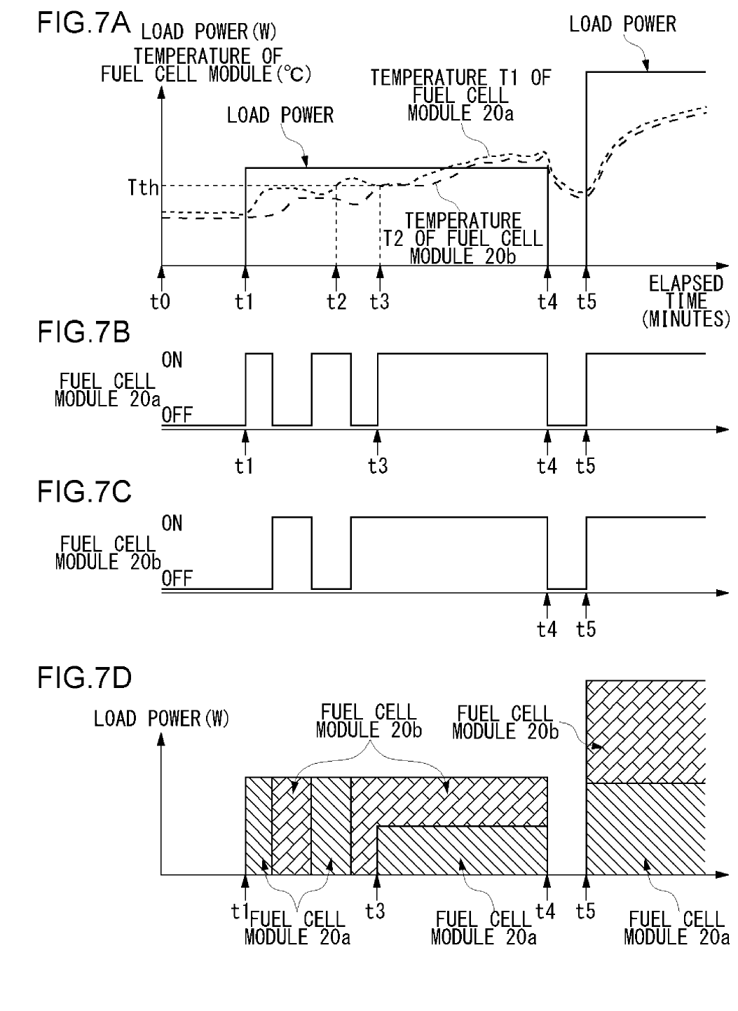

FIGS. 7A to 7D are timing charts showing a first exemplary operation of the fuel cell system 10. FIG. 7A shows a temporal change in the load power. FIG. 7B shows a connection status (change in on/off state) in the fuel cell module 20a. FIG. 7C shows a connection status (change in on/off state) in the fuel cell module 20b. FIG. 7D shows a change in the power for each fuel cell module. In this exemplary case, the fuel cell system 10 is not provided with the secondary cell 50 and the secondary cell control circuit 52.

At an initial state (time t0), no external load is applied, and the temperatures (ambient temperatures) of the fuel cell module 20a and the second fuel cell module 20b are each the threshold value Tth or below. In this state, both the fuel cell module 20a and the fuel cell module 20b are not generating any power and are cut from the external load.

At time t1, the external load starts to be applied. The external load at this time is a low load and is at the predetermined threshold value Wth or below. With time t1 set as a base point, the charging starts in the fuel cell module 20a and the fuel cell module 20b. In this state, the temperatures of the fuel cell module 20a and the fuel cell module 20b both continue to be at the threshold value Tth or below. Thus, the fuel cell module 20a and the fuel cell module 20b are alternately connected to the external load. That is, the power suitable for the external load is managed and covered by the power generated by either one of the fuel cell module 20a and the fuel cell module 20b.

At time t2, the temperature of the fuel cell module 20a becomes higher than the threshold value Tth but the temperature of the fuel cell module 20b is at the threshold value Tth or below. Thus, the fuel cell module 20a and the fuel cell module 20b continue to be alternately connected to the external load.

At time t3, the temperatures of the fuel cell module 20a and the fuel cell module 20b both become higher than the threshold value Tth. Thus, with time t3 set as a base point, both the fuel cell module 20a and the fuel cell module 20b are connected to the external load. That is, at this state, the power suitable for the external load is supplied from both the fuel cell module 20a and the fuel cell module 20b by dividing the generated power therebetween.

At time t4 when the external load stops, the fuel cell module 20a and the fuel cell module 20b are cut off from the external load.

Then, at time t5, the external load starts at a state of load higher than the predetermined threshold value Wth (maximum load). In this case, both the fuel cell module 20a and the fuel cell module 20b are connected to the external load, and the power suitable for the external load is divided by the power generated between the fuel cell module 20a and the fuel cell module 20b. At this time, the current flowing to the fuel cell modules 20 is equal to that flowing thereto at a low load under the switching operation.

### Examples

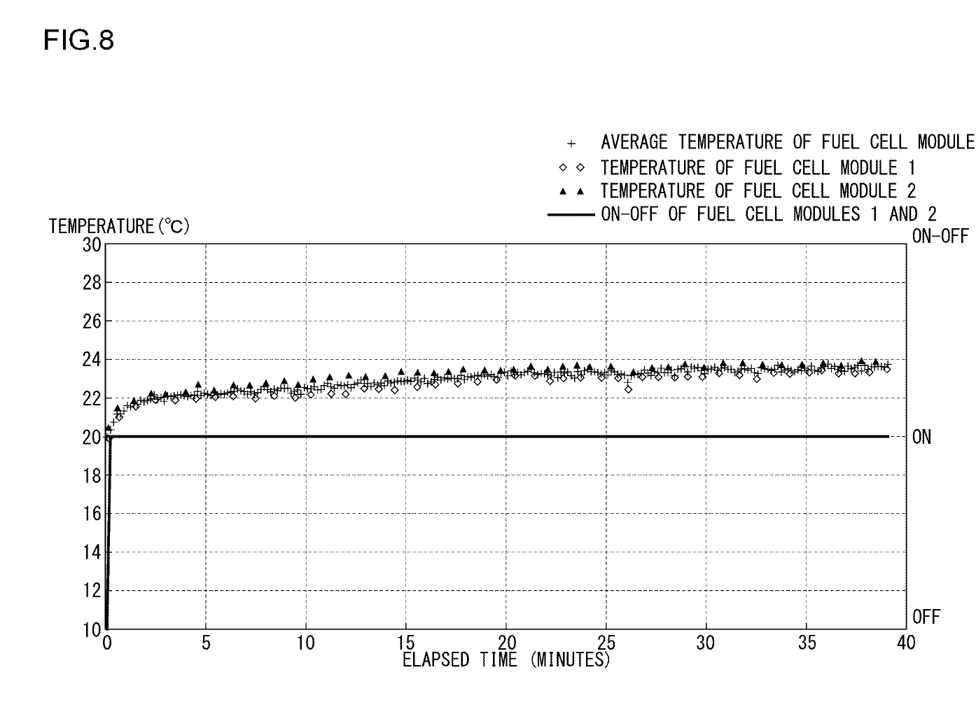

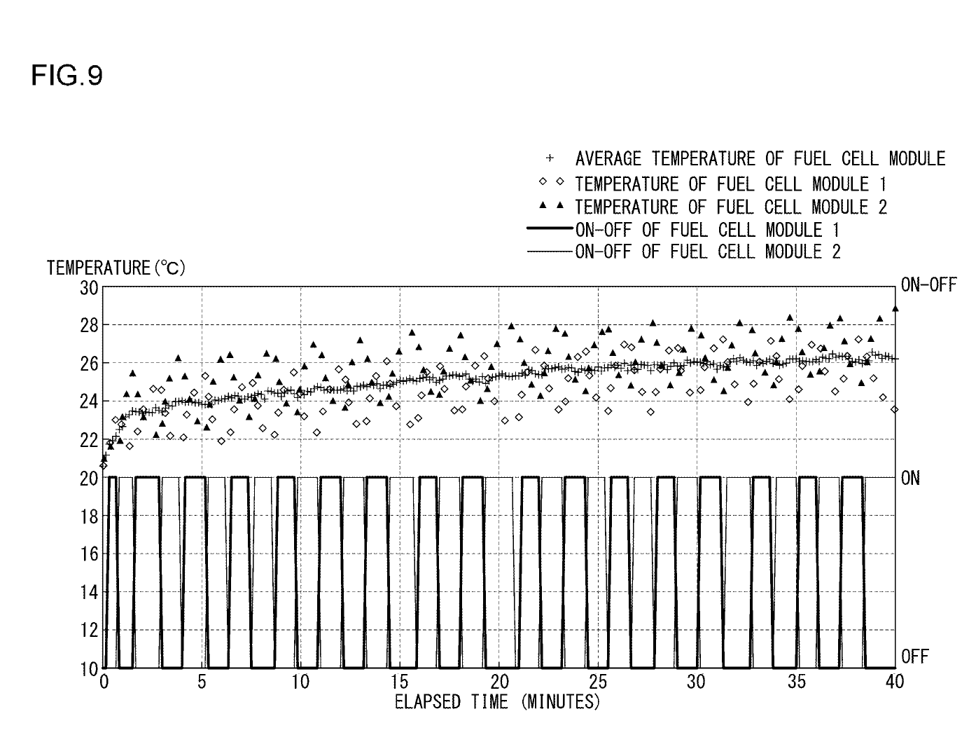

FIG. 8 and FIG. 9 are graphs to show the advantageous effects of the present embodiment. FIG. 8 and FIG. 9 are data when a fuel cell system, which is comprised of two fuel cell modules, is operated at one half of rated output power under environmental conditions where the temperature is 20° C. and the humidity is 50% RH. FIG. 8 shows a case where a conventional method is used and two fuel cell modules are connected to a load. FIG. 9 shows a case where a connection method according to a first exemplary operation and two fuel cell module are alternately connected to a load at every one minute.

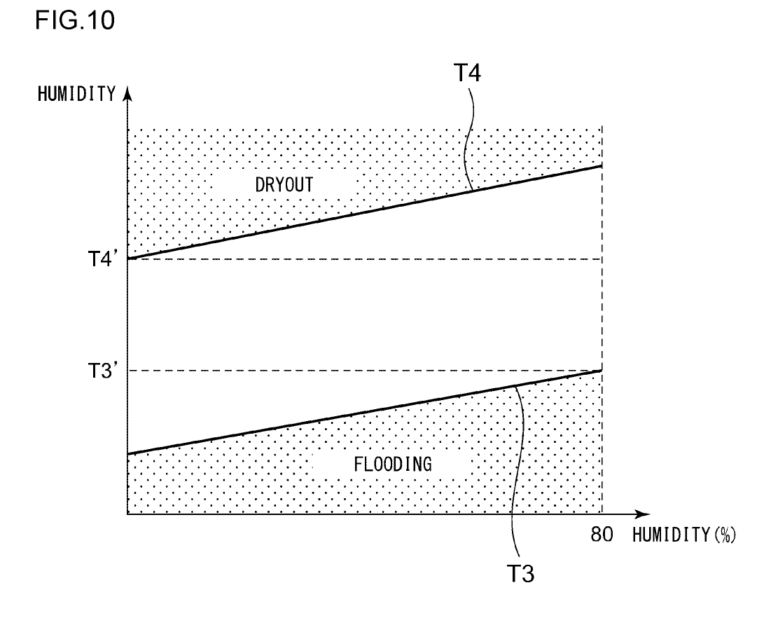

Comparing FIG. 9 with FIG. 8, an average surface temperature of the fuel cell modules is 23 degrees after 30 minutes from the start of operation in the conventional control method, whereas it is 26 degrees after 30 minutes from the start of operation in the control method of the first exemplary operation. Thus, there is a difference of 3° C. in the temperature. The generated water condensates in the fuel cell modules according to the conventional example, whereas the generated water does not condensate in the first exemplary operation. Though the experiment was carried out in the first exemplary operation under the aforementioned limited environmental conditions where the temperature is 20° C. and the humidity is 50% RH, it is possible that in the conventional example, the operation of the fuel cells becomes unstable due to the flooding if the experiment is further conducted at the environmental conditions of a lower temperature and a higher humidity. In the first exemplary operation, if the environmental condition varies, the number of fuel cells that divide the power generation will be increased, so that the range in which the stable operation is achievable can be broadened. To see this, a description is given of dry-out and flooding in the fuel cell system relative to the change in temperature and humidity of ambient environment. FIG. 10 is a graph showing the dependence of dry-out temperature T4 and flooding temperature T1 on the humidity. As the humidity increases, the dry-out temperature T4 and the flooding temperature T1 rise. Thus the start temperatures of dry-out and flooding of the fuel cell vary depending on the humidity. For example, since a flooding temperature T3 increases under the condition of high humidity, flooding is more likely to occur. Thus, the temperature needs to be controlled according to a change in the ambient environment. The graph shown in FIG. 10 is merely an example and it varies depending on the output of a fuel cell system.

In FIG. 10, a temperature T4′ is a lower limit of the dry-out temperature T4 (a dry-out temperature under a low-humidity condition where the humidity is 20%, for instance). Also, a temperature T3′ is an upper limit of the flooding temperature T3 (a flooding temperature under a high-humidity condition where the humidity is 80%, for instance). As shown in FIG. 10, even though the humidity varies, neither of dry-out and flooding occurs in a temperature range of temperature T3′ to temperature T4′. This indicates that the temperature range of temperature T3′ to temperature T4′ is a temperature range where the fuel cell can stably generate power independently of humidity. By performing the control of the first exemplary operation, the temperature range where the fuel cell can stably generate power is broadened.

(Description of Second Exemplary Operation)

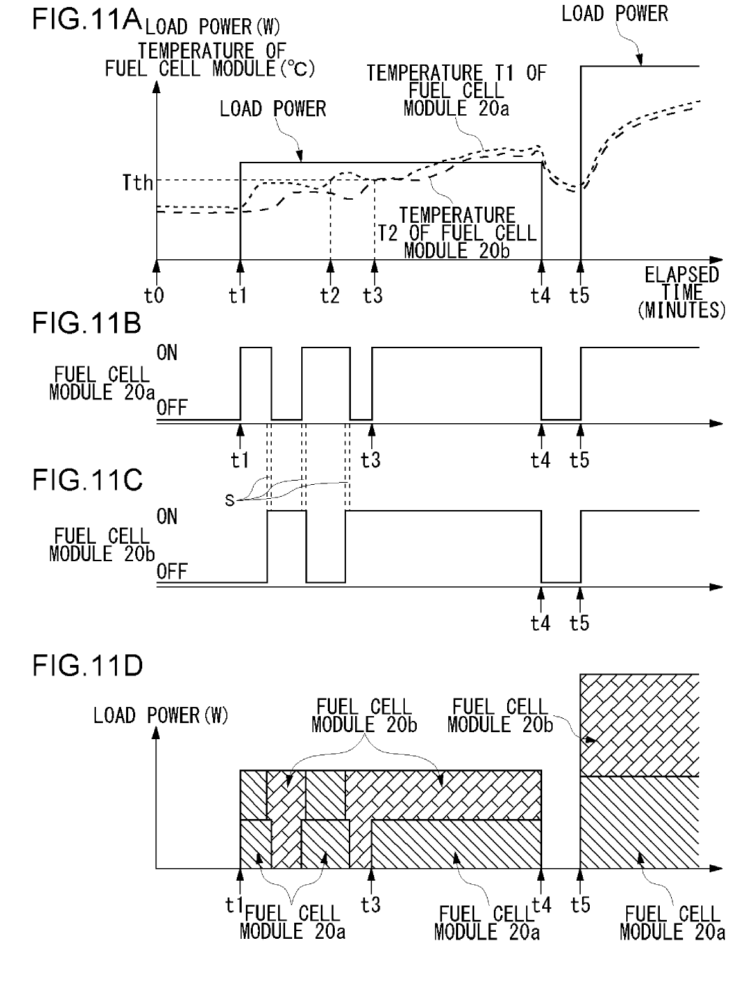

FIGS. 11A to 11D are timing charts showing a second exemplary operation of the fuel cell system 10. FIG. 11A shows a temporal change in the external load. FIG. 11B shows a connection status (change in on/off state) in the fuel cell module 20a. FIG. 11C shows a connection status (change in on/off state) in the fuel cell module 20b. FIG. 11D shows a change in the power for each fuel cell module.

A difference between the first exemplary operation and the second exemplary operation is that there is an interval S during which both the fuel cell module 20a and the fuel cell module 20b are connected to the external load, when the fuel cell module 20a and the fuel cell module 20b are switched during an interval of the switching operation of the fuel cell module 20a and the fuel cell module 20b from time t1 to time t2. Thus, an abrupt load variation by each fuel cell module 20 is suppressed and therefore the deterioration of each signal cell or the fuel cell modules 20 can be prevented. As a result, the output of each fuel cell module 20 can be stabilized. Also, the switching operation between the fuel cell module 20a and the fuel cell module 20b can be more smoothly performed.

By employing the fuel cell system as described above, the number of fuel cell modules connected to the external load is varied according to the external load. Thus, the value of current flowing to each fuel cell module 20 can be made equal even though the external load varies. As a result, the temperature of the fuel cell modules 20 transits within a prescribed range and therefore the dry-out or condensation of generated water are suppressed. Consequently, the power generation operation of the fuel cell system 10 can be further stabilized.

The connection of the fuel cell modules to the external load is sequentially switched if the external load is low. This allows time for the generated water occurring in each fuel cell module 20 to evaporate. Also, performing the switching operation allows the temperature within the surface of each single cell to distribute evenly.

The fuel cell system according to the present embodiments is effective in a case where air (oxygen) is supplied to the cathode using a passive method without the use of auxiliaries, such as a circulation pump and a humidifier, and the fuel is supplied to the anode using a dead-end method in which the fuel is refilled in such a manner as to supplement the fuel (hydrogen) consumed by a reaction.

In an active method where air and fuel are supplied by the use of an external power, the supply of fuel and air is turned on and off according to the on/off of the current load, for each of the fuel cell modules. Thus the same advantageous effects as those in the fuel cell system using the passive method can be achieved.

(Second Operation Flow in a Fuel Cell System)

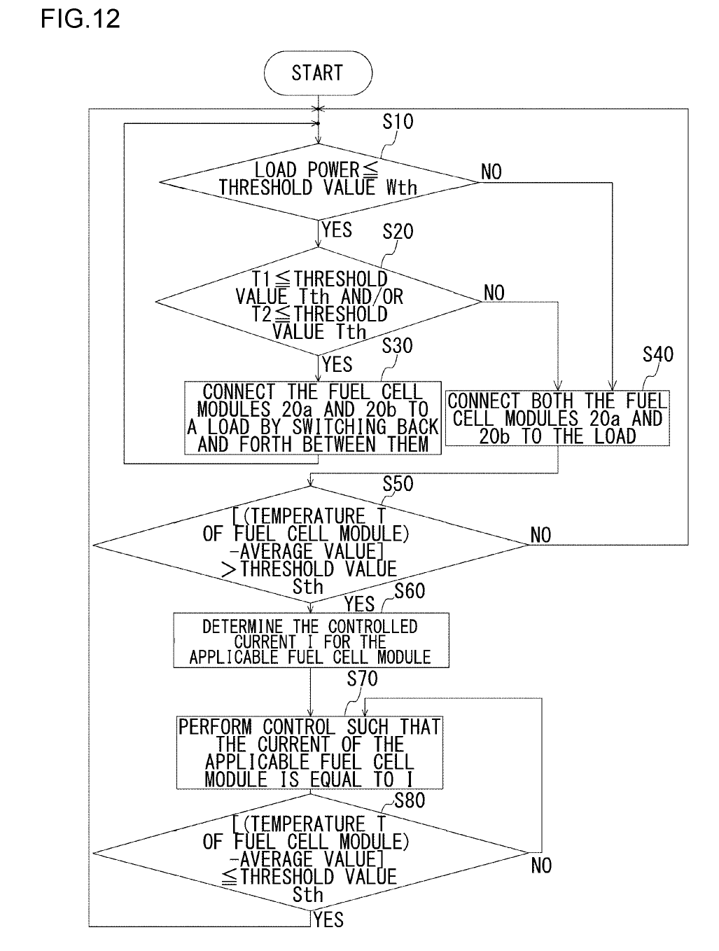

FIG. 12 is a second flowchart showing an operation of the fuel cell system 10 according to an embodiment. The processings in Steps S10, S20, S30 and S40 in this second operation flow are the same as those in the first operation flow of the fuel cell system 10. In this operation flow, whether differences S1 and S2, obtained by subtracting an average value from the temperatures T1 and T2 of the respective fuel cell modules, are higher than a threshold value Sth or not is determined (S50) after the both fuel cell modules 20a and 20b have been connected to the load in Step S40. The average value meant here is the average value of the temperature T1 of the fuel cell module 20a and the temperature T2 of the fuel cell module 20b. If the differences are less than or equal to the threshold value Sth (N of S50), the process will return to Step S10. If, on the other hand, the differences are greater than the threshold value Sth (Y of S50), a controlled current value I of the applicable fuel cell module will be determined (S60). As a method for determining the controlled current value I, for example, the controlled current value I may be set in memory or the like, according to the differences between the temperatures of the fuel cell modules and the average value. Subsequently, a switch provided corresponding to a fuel cell module on which the control of current flowing thereto is to be performed is continuously turned on and off. Thus, the control is performed such that the current flowing to the applicable fuel cell module is the controlled current value I (S70). For the fuel cell module on which the current control has been performed, the heat generation rate drops as the amount of power generation drops. Eventually the rate of rise of temperature becomes sluggish or the temperature drops. For the fuel cell module on which the current control is not performed, however, the amount of generation increases to cover the output of the fuel cell whose current has been controlled. Thereby, the heat generation rate of the fuel cell module, whose current is not controlled, rises, and the temperature also rises. As a result, the temperature difference between each fuel cell module is reduced. After the current control has been performed for a predetermined duration of time (one second, for instance), whether the difference obtained by subtracting the average value from the temperature of each fuel cell module is less than or equal to the threshold value Sth or not is determined (S80). If the difference is the threshold value Sth or below (Yes of S80), the process will return to the determination in Step S10. If, on the other hand, the difference is larger than the threshold value Sth (No of S80), the process will return to Step S70 and the current control continues.

Though the number of fuel cell modules is two in this flowchart, the operation flow as described above is also applicable to the case where the number of fuel cell modules is three or more. In such a case, the average value used for the determination of Step S50 is an average value of the temperatures of three or more fuel cell modules, and Steps S50 to S80 will be carried out for each of fuel cell module.

(Description of Third Exemplary Operation)

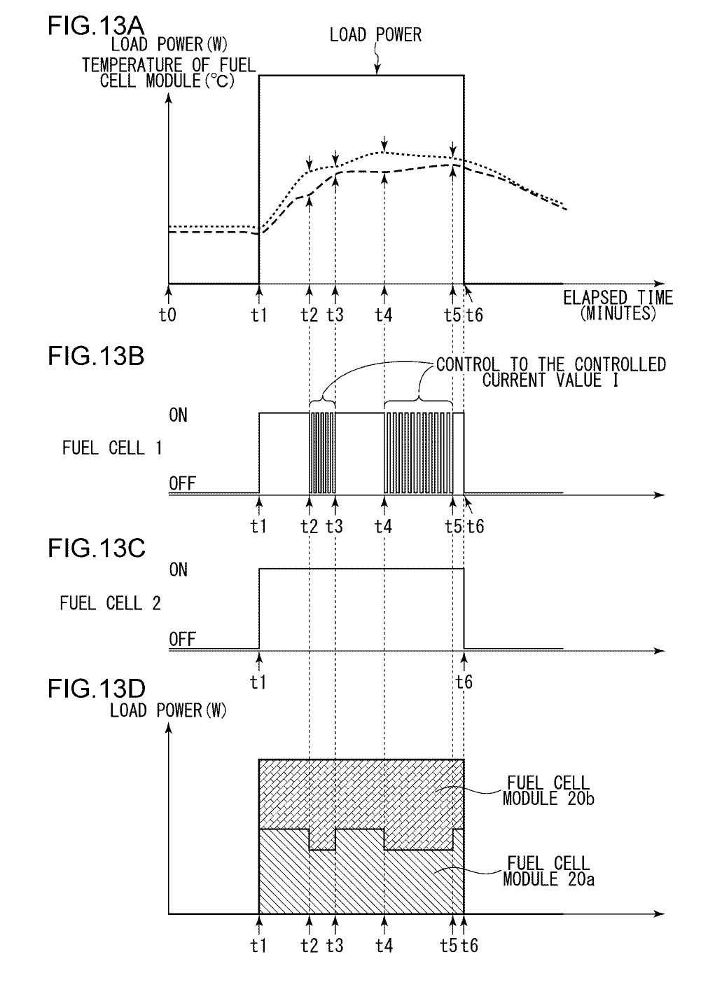

FIGS. 13A to 13D are timing charts showing a third exemplary operation of the fuel cell system 10. FIG. 13A shows a temporal change in the external load. FIG. 13B shows a connection status (change in on/off state) in the fuel cell module 20a. FIG. 13C shows a connection status (change in on/off state) in the fuel cell module 20b. FIG. 13D shows a change in the power for each fuel cell module.

FIGS. 13A to 13D show a case where the load is higher than the threshold value Wth (No of S10). At an initial state (time t0), no external load is applied, and the temperatures (ambient temperatures) of the fuel cell module 20a and the second fuel cell module 20b are each the threshold value Tth or below. In this state, both the fuel cell module 20a and the fuel cell module 20b are not generating any power and are cut from the external load.

At time t1, the external load starts to be applied. The external load at this time is a high load and is higher than the predetermined threshold value Wth or below. With time t1 set as a base point, the charging starts in the fuel cell module 20a and the fuel cell module 20b, and the power suitable for the external load is managed and covered by the power generated by both the fuel cell module 20a and the fuel cell module 20b.

As, at time t2, the difference S1, obtained by subtracting the average value from the temperature T1 of the fuel cell module 20a, becomes higher than the threshold value Sth, the current flowing to the fuel cell module 20a is set to the controlled current value I by turning on and off the load of the fuel cell module 20a instantaneously (in a range of about several 100 Hz to several MHz). If the current flowing to the fuel cell module 20a is to be controlled, the on-off duty ratio of the fuel cell module 20a may be set to a predetermined value. While the current flowing to the fuel cell module 20a is being controlled, the current flowing to the fuel cell module 20b increases to supplement the output of the fuel cell module 20a. While the current flowing to the fuel cell module 20a is being controlled, the output of the fuel cell module 20b is higher than the output of the fuel cell module 20a. After time t2, the rise in temperature of the fuel cell module 20a on which the current control is performed becomes low, and the rise in temperature of the fuel cell module 20b on which the current control is not performed increases. As a result, the difference in temperature between the fuel cell module 20a and the fuel cell module 20b is reduced.

As, at time t3, the difference S1, obtained by subtracting the average value from the temperature T1 of the fuel cell module 20a, becomes less than or equal to the threshold value Sth, the current control for the fuel cell module 20a is terminated. Thereafter, the current control starts to be performed on the other fuel cell module at time t4, and the current control performed on the other fuel cell module is terminated at time t5.

(Third Operation Flow of Fuel Cell System)

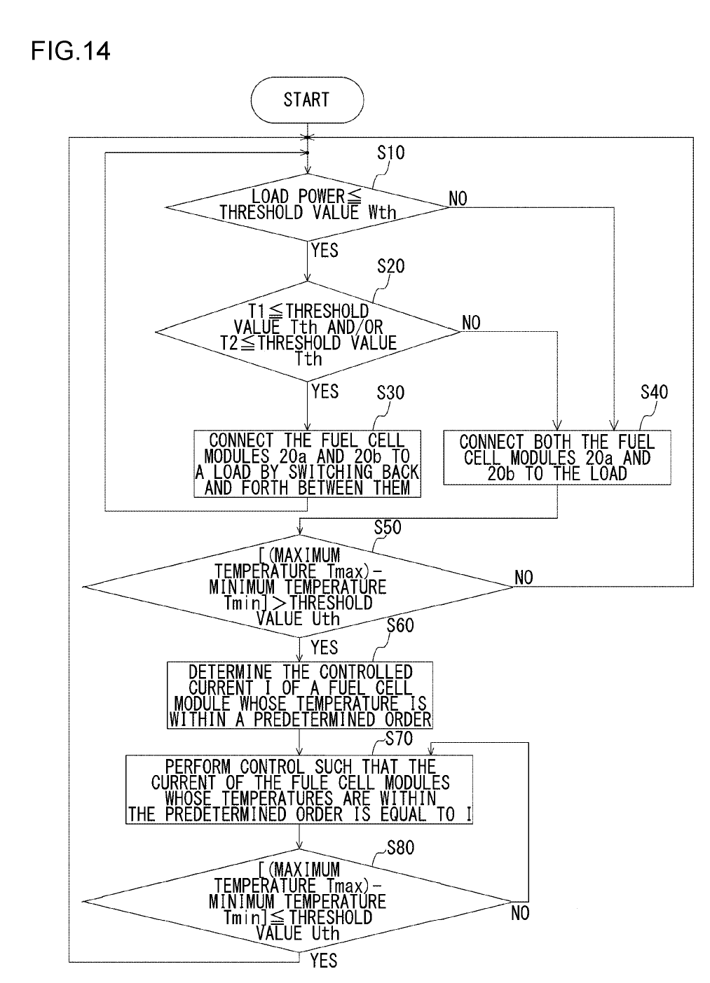

FIG. 14 is a third flowchart showing an operation of the fuel cell system 10 according to an embodiment. The processings in Steps S10, S20, S30 and S40 in this third operation flow are the same as those in the first operation flow of the fuel cell system 10. In this operation flow, whether the value, obtained by subtracting a minimum temperature Tmin from a maximum temperature Tmax is higher than a threshold value Uth or not is determined (S50) after the both fuel cell modules 20a and 20b have been connected to the load in Step S40. The maximum temperature Tmax is the temperature of a fuel cell module whose temperature becomes maximum among a plurality of fuel cell modules. The minimum temperature Tmin is the temperature of a fuel cell module whose temperature becomes minimum among the plurality of fuel cell modules. In this third operation flow, the temperature of the fuel cell module 20a is the maximum temperature Tmax, whereas the temperature of the fuel cell module 20b is the minimum temperature Tmin. If the value, obtained by subtracting the minimum temperature Tmin from the maximum temperature Tmax is the threshold value Uth or below (No of S50), the process will return to Step S10. If, on the other hand, the value, obtained by subtracting the minimum temperature Tmin from the maximum temperature Tmax is higher than the threshold value Uth (Yes of S50), the controlled current value I for a limited number of fuel cell modules whose temperatures are in a predetermined descending order will be determined (S60). For example, if the number of fuel cell modules is two as in this operation flow, the controlled current I for one fuel cell module whose temperature is higher than the other will be determined. Also, if the number of fuel cell modules is n (n being an integer greater than or equal to 3), the controlled current I for fuel cell modules in descending order of temperature (greater than or equal to 1 and less than or equal to n−1) starting from one with the highest temperature to one with a certain high temperature will be determined. Subsequently, switches provided corresponding to the fuel cell modules on which the control of current flowing thereto is to be performed are continuously turned on and off. Thus, the control is performed such that the current flowing to the applicable fuel cell modules is the controlled current value I (S70). For the fuel cell modules on which the current control has been performed, the heat generation rate drops as the amount of power generation drops. Eventually the rate of rise of temperature becomes sluggish or the temperature drops. For the fuel cell modules on which the current control is not performed, however, the amount of generation increases to cover the output of the fuel cells whose currents have been controlled. Thereby, the heat generation rate of the fuel cell modules, whose currents are not controlled, rises, and the temperatures also rise. As a result, the temperature difference between each fuel cell module is reduced. After the current control has been performed for a predetermined duration of time (one second, for instance), whether the difference obtained by subtracting the minimum temperature Tmin from the maximum temperature Tmax is less than or equal to the threshold value Uth or not is determined (S80). If the difference is the threshold value Sth or below (Yes of S80), the process will return to the determination in Step S10. If, on the other hand, the difference is larger than the threshold value Uth (No of S80), the process will return to Step S70 and the current control continues.

According to the operations described by the second flowchart and the third flowchart, the difference in temperature between the fuel cell modules is minimized in the event that variations in temperature occurs in the fuel cell modules, so that the temperatures of the fuel cell modules can be kept uniform. This eliminates the need of a mechanism to individually cool the fuel cell modules and individually control them, thereby simplifying the structure of the fuel cell system.

(First Modification)

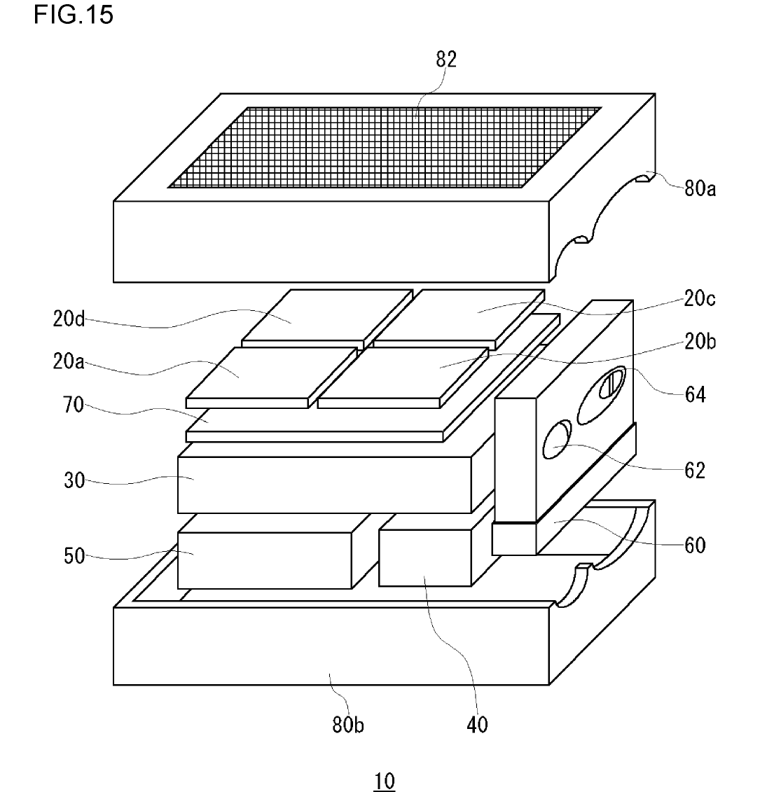

The number of fuel cell modules connected in parallel with the external load is not limited to two, and three and more may be connected in parallel with the external load. For example, as shown in FIG. 15, a fuel cell system according to a first modification has four fuel cell modules 20a to 20d. If the four fuel cell modules 20a to 20d are connected in parallel with the external load and also if the switching operation is to be performed on the fuel cell modules, the number of fuel cell modules connected simultaneously to the external load can be set to one, two or three. The external loads suitable for the cases where the numbers of fuel cell modules simultaneously connected to the external load are 1, 2 and 3 are 25%, 50% and 75% relative to the maximum load, respectively.

TABLE 1

| | Connection | Connection | Connection | Connection |
|---|---|---|---|---|
| | status 1 | Status 2 | Status 3 | Status 4 |
| Fuel cell | ON | OFF | OFF | ON |
| module 20a | | | | |
| Fuel cell | ON | ON | OFF | OFF |
| module 20b | | | | |
| Fuel cell | OFF | ON | ON | OFF |
| module 20c | | | | |
| Fuel cell | OFF | OFF | ON | ON |
| module 20d | | | | |

Table 1 shows the connection status of each of four fuel cell modules 20 connected simultaneously to the external load when they perform the switching operation in response to a 50% load. In Table 1, “ON” indicates that a fuel cell is connected to the external load, and “OFF” indicates that it is cut off from the external load. The connection status during the switching operation transits in the repeated order of connection status 1→connection status 2→connection status 3→connection status 4→connection status 1. In each connection status, two of the four fuel cell modules 20 are connected to the external load. Accordingly, the load relative to each fuel cell module 20 is a 25% load, which is equal to the load relative to each fuel cell module at the maximum load. In other words, the current density of each fuel cell module 20 remains constant even if the load varies. As a result, the temperature of the fuel cell modules 20 remains within a fixed range and therefore the dry-out and the condensation of generated water are suppressed. Consequently, the power generation operation of the fuel cell system 10 can be further stabilized.

Here, the number of fuel cell modules electrically connected in parallel with the load is generalized to n. If the number of fuel cell modules simultaneously connected to the load is set to m/n (m=1, 2, 3, . . . , n−1) according to the load and also if the temperature of at least one of the fuel cell modules is less than or equal to a predetermined temperature, the switching operation can be performed. More specifically, when the external load becomes m/n or below based on a maximum load, the fuel cell modules connected to the load are sequentially switched by using a connection switching means in such a manner that the number of fuel cell modules simultaneously connected to the load is m.

Next, a description is given of another control method. In this control method, all of the fuel cell modules are connected to the load even though the load is low. And the switching operation of switching the fuel cell modules simultaneously connected to the load according to the load power is performed only if the occurrence of flooding is detected. The flooding is detected as follows. If the output voltage of at least one of the fuel cell modules falls below a predetermined voltage value relative to a predetermined current value or if a variation of the output voltage of at least one of the fuel cell modules is higher than or equal to a predetermined range of variation, it will be detected as the flooding. In this manner, the switching operation of switching the fuel cell modules simultaneously connected to the load according to the load power is performed only if the flooding is detected. Thus, the load of the fuel cell modules in operation approaches the rating and the flooding and the like problems are resolved, and thereby the power generation status of these fuel cell modules is improved and the outputs thereof are stabilized. At the same time, the diffusion polarization and the like are reduced, so that the fuel can be used effectively and therefore the fuel efficiency can be improved.

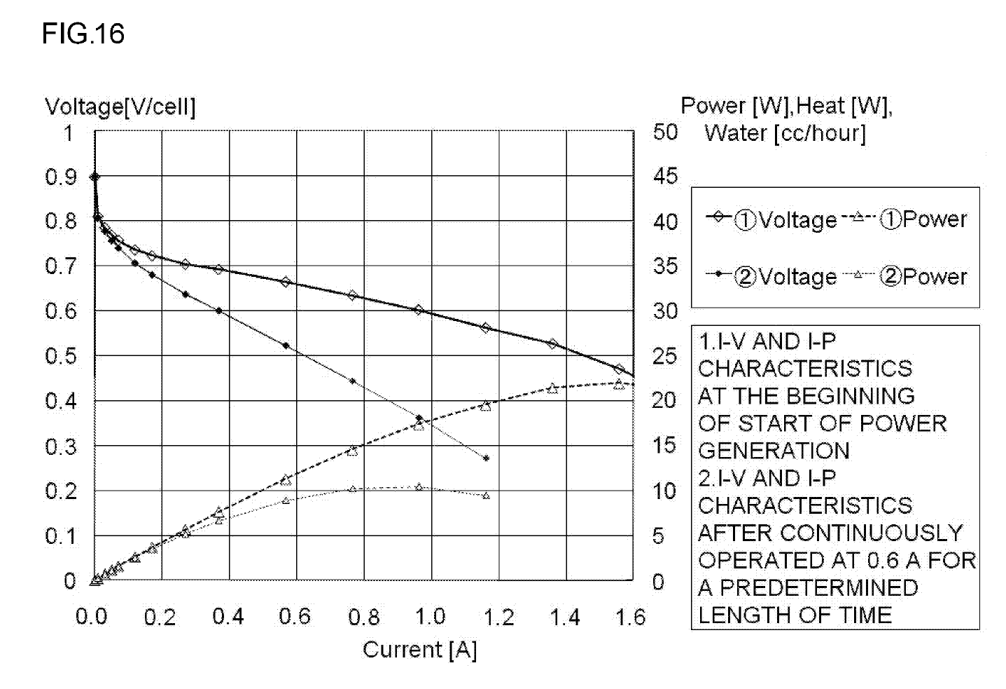

FIG. 16 is a conceptual diagram showing I-V characteristics and I-P characteristics of a fuel cell module at the beginning of start of power generation and also showing I-V characteristics and I-P characteristics of a fuel cell module after continuously operated under a low load, with flooding occurring, for a predetermined length of time. In this example described in conjunction with FIG. 16, it is designed that a fuel cell module is operated in 1.2 A. If the fuel cell module is operated at ½ of the load, namely 0.6 A, the voltage of the fuel cell module will be 0.65 V. However, in this case, the flooding occurs, after a start of the power generation, because the generated water condensates. Thus, if the fuel cell module continues to operate at 0.6 A after a certain period of time has elapsed after the start thereof, the voltage of the fuel cell module will be about 0.5 V. In order for the output voltage of the fuel cell not to drop like this, only the fuel cell modules operating in ½ of load are allow to generate the electric power (if the load is ½ and) if the voltage drop or variation is detected due to the flooding. As a result, the current density of the fuel cell module is raised and also the surface temperature of the fuel cell module is raised so as to evaporate the generated water. Thus the flooding can be resolved and the deteriorations in I-V and I-P characteristics can be prevented.

(Second Modification)

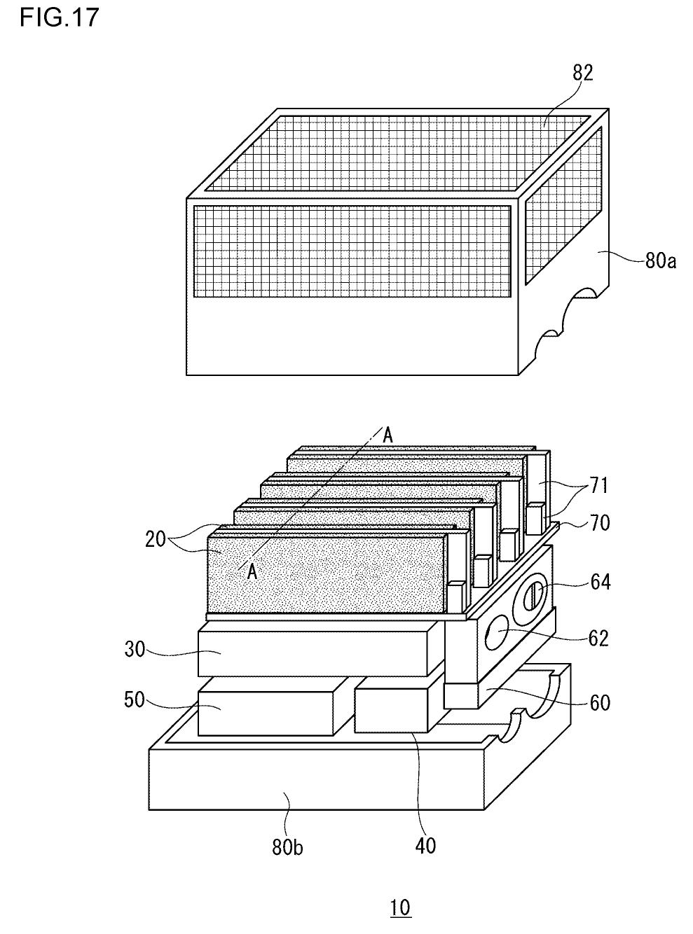

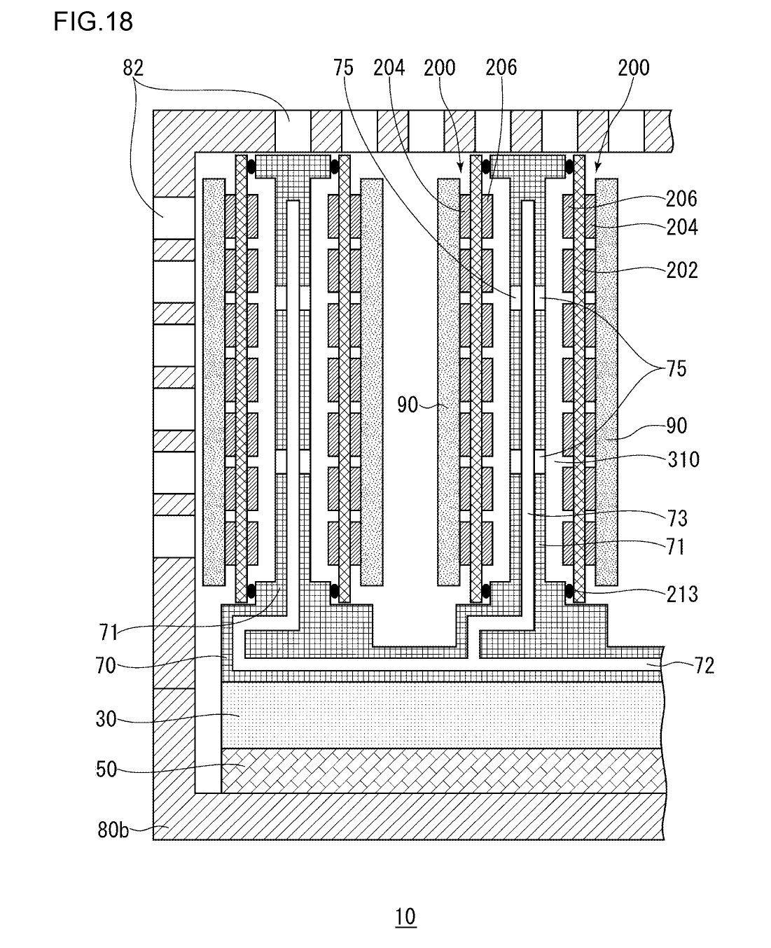

In the above-described embodiments and modification, a plurality of fuel cell modules are arranged in a plane. However, the form of arrangement for the fuel cell modules is not limited thereto. FIG. 17 is an exploded perspective view showing a rough structure of a fuel cell system according to a second modification. FIG. 18 is a feature sectional view showing a rough structure of the fuel cell system according to the second modification.

In this second modification, one main surfaces of adjacent fuel cell modules 20 are installed side by side in such a manner as to face each other. Though the form of arrangement for the fuel cell modules according to the second modification differs from the arrangement for the above-described embodiments and first modification, the operation of the fuel cell modules according to this second modification is similar to that of the fuel cell modules 20 according to the above-described embodiments and first modification.

A fuel supply plate 71 projecting above from the fuel supply plate 70 is provided for each pair of fuel cell modules 20. A fuel conduit 73 communicating with a fuel conduit 72 is provided inside each fuel supply plate 71. Openings 75 which are outlet ends of the fuel conduit 73 are provided, respectively, on both main surfaces of the fuel supply plate 71.

Each fuel cell module 20 is provided on the both main surfaces of the fuel supply plate 71 in such a manner that the anodes face the both main surfaces thereof. Packings 213 are provided between a periphery of an electrolyte membrane 202 and the fuel supply plate 71, and an anode space 310 used to trap hydrogen therein is formed between the fuel supply plate 71 and an anode side of the fuel cell module 20.

Hydrogen is distributed to each fuel conduit 73 from the fuel conduit 72 and then supplied to a anode catalyst layer 206 of two pairs of fuel cell modules 20 disposed on the both main surfaces of the fuel cell plate 71.

Air inlets 82 are provided on the top face and sides of the top casing 80a. Air that flowing in through the air inlets 82 passes through a porous material 90 and is then supplied to a cathode layer 204 of each fuel cell module 20.

The operation of the fuel cell system according to the above-described embodiments is applied to the fuel cell system of the above-described second modification. The same advantageous effects achieved by the fuel cell system according to the above-described embodiments are also achieved in the structure where main surfaces of a plurality of fuel cell modules 20 face each other.

The present invention has been described by referring to the above-described embodiment and modification. However, the present invention is not limited to the above-described embodiments only. It is understood that various modifications such as changes in design may be further made based on the knowledge of those skilled in the art, and the embodiments added with such modifications are also within the scope of the present invention.

Though each fuel cell module is structured by a plurality of cells in the above-described embodiments, each fuel cell module may be structured by a single cell, for example. In such a case, a voltage adjustment circuit is provided, so that the external load can be driven by boosting the output voltage in response to the voltage of each fuel cell module.

What is claimed is:

1. A fuel cell system, comprising:
fuel cell modules of n units electrically connected in parallel with an external load, n being an integer greater than or equal to 2;
a connection switching means capable of switching a connection between each of said fuel cell modules and the external load; and
a control unit configured to perform a switching operation of switching the fuel cell modules, connected to the external load, by using said connection switching means, in such manner that the number of fuel cell modules simultaneously connected to the external load is m (m=1, 2, 3, . . . , n−1) according to the external load, when the temperature of at least one of the fuel cell modules is less than or equal to a predetermined temperature.

2. A fuel cell system according to claim 1, wherein said fuel cell modules of n units are arranged in a plane.

3. A fuel cell system according to claim 1, wherein said fuel cell modules of n units are disposed in parallel in such a manner that main surfaces of the adjacent fuel cell module face each other.

4. A fuel cell system according to claim 1, wherein said control unit switches a combination of the fuel cell modules connected to the external load, at every fixed times.

5. A fuel cell system according to claim 4, wherein said control unit performs control such that when the external load is to be switched, a fuel cell module to be connected to the external load is connected to the external load before a fuel cell module to be cut off from the external load is cut off from the external load.

6. A fuel cell system according to claim 2, wherein said control unit switches a combination of the fuel cell modules connected to the external load, at every fixed times.

7. A fuel cell system according to claim 3, wherein said control unit switches a combination of the fuel cell modules connected to the external load, at every fixed times.

8. A fuel cell system according to claim 1, wherein when the temperature of each of said fuel cell modules of n units becomes higher than a predetermined temperature, said control unit connects said fuel cell modules of n units to the external load.

9. A fuel cell system according to claim 2, wherein when the temperature of each of said fuel cell modules of n units becomes higher than a predetermined temperature, said control unit connects said fuel cell modules of n units to the external load.

10. A fuel cell system according to claim 3, wherein when the temperature of each of said fuel cell modules of n units becomes higher than a predetermined temperature, said control unit connects said fuel cell modules of n units to the external load.

11. A fuel cell system according to claim 1, wherein when said control unit performs the switching operation, said control unit connects the fuel cell modules to be connected to the external load, to the external load, and
after a predetermined length of time has elapsed, said control unit cuts off a fuel cell module to be cut off from the external load, from the external load.

12. A fuel cell system according to claim 2, wherein when said control unit performs the switching operation, said control unit connects the fuel cell modules to be connected to the external load, to the external load, and
after a predetermined length of time has elapsed, said control unit cuts off a fuel cell module to be cut off from the external load, from the external load.

13. A fuel cell system according to claim 3, wherein when said control unit performs the switching operation, said control unit connects the fuel cell modules to be connected to the external load, to the external load, and
after a predetermined length of time has elapsed, said control unit cuts off a fuel cell module to be cut off from the external load, from the external load.

14. A fuel cell system according to claim 1, wherein when the external load becomes m/n based on a maximum load, said control unit performs the switching operation of sequentially switching the fuel cell modules connected to the external load by using said connection switching means in such a manner that the number of fuel cell modules simultaneously connected to the external load is m.

15. A fuel cell system according to claim 2, wherein when the external load becomes m/n or below based on a maximum load, said control unit performs the switching operation of sequentially switching the fuel cell modules connected to the external load by using said connection switching means in such a manner that the number of fuel cell modules simultaneously connected to the external load is m.

16. A fuel cell system according to claim 3, wherein when the external load becomes m/n or below based on a maximum load, said control unit performs the switching operation of sequentially switching the fuel cell modules connected to the external load by using said connection switching means in such a manner that the number of fuel cell modules simultaneously connected to the external load is m.

17. A fuel cell system according to claim 1, wherein when the temperature of any particular fuel cell module is higher than an average value of said all fuel cell modules of n units by at least a predetermined value, said control unit restricts the current of the any particular fuel module according to the temperature of the any particular fuel cell module.

18. A fuel cell system according to claim 1, wherein when the difference between a maximum temperature and a minimum temperature in temperatures of said all fuel cell modules of n units is larger than a predetermined value, said control unit restricts the current of a single fuel cell module or a plurality of fuel cell modules in descending order in temperature among said all fuel cell modules of n units.

19. A fuel cell system, comprising:
fuel cell modules of n units electrically connected in parallel with an external load, n being an integer greater than or equal to 2;
a connection switching means capable of switching a connection between each of said fuel cell modules and the external load; and
a control unit configured to perform a switching operation of switching the fuel cell modules, connected to the external load, by using said connection switching means, in such manner that the number of fuel cell modules simultaneously connected to the external load is m (m=1, 2, 3, . . . , n−1) according to the external load, when a voltage value relative to a current value of at least one of the fuel cell modules is less than a predetermined value or when a variation of the voltage value relative to a current value of at least one of the fuel cell modules is greater than or equal to a predetermined range of variation.
